(19) United States
(12) Patent Application Publication
(10) Pub. No.: US 2024/0212171 A1
(43) Pub. Date: Jun. 27, 2024

(54) IMAGE PROCESSING APPARATUS

(71) Applicant: SUBARU CORPORATION, Tokyo (JP)

(72) Inventor: Naoki TAKAHASHI, Tokyo (JP)

(21) Appl. No.: 18/537,564

(22) Filed: Dec. 12, 2023

(30) Foreign Application Priority Data
Dec. 21, 2022 (JP) 2022-204607

(51) Int. Cl. G06T 7/246; G06T 7/13; G06T 7/55; G06T 7/60

(52) U.S. Cl. CPC G06T 7/248; G06T 7/13; G06T 7/55; G06T 7/60; G06T 2207/10028; G06T 2207/20072; G06T 2207/20076; G06T 2207/30236; G06T 2207/30252

(57) ABSTRACT

An image processing apparatus includes a distance histogram generator, a computation processor, an extractor, and a movement amount calculator. The distance histogram generator generates, for each horizontal angle of view of an imaging unit mounted on a vehicle, a distance histogram based on distance data of a distance image captured by the imaging unit. The distance image has a pixel value corresponding to a distance to a crossing object in captured images of the front of a vehicle. The computation processor computes edge histogram data for each distance histogram. The extractor extracts, from the edge histogram data computed in the past, any edge histogram data matching with the edge histogram data computed latest. The movement amount calculator calculates a movement amount of the object in a vehicle width direction, based on a difference between the extracted edge histogram data computed in the past and the edge histogram data computed latest.

### CROSS-REFERENCE TO RELATED APPLICATIONS

The present application claims priority from Japanese Patent Application No. 2022-204607 filed on Dec. 21, 2022, the entire contents of which are hereby incorporated by reference.

### BACKGROUND

The disclosure relates to an image processing apparatus.

In general, a technique is available in which a distance to a crossing object located near a vehicle is detected based on an image captured by a stereo camera mounted on the vehicle.

With recent advancement of data processing techniques and image processing techniques, the foregoing technique has evolved into a technique of rapidly detecting a human, a vehicle, or other objects.

Further, by applying such a technique, a vehicle has been proposed that has a function of preventing contact of the vehicle with a human, an animal, another vehicle, or other objects by executing automatic braking control before the contact occurs.

To implement the above-described function, a tracking technique is usable in performing measurements using images captured by the stereo camera. According to the tracking technique, when a crossing object, such as another vehicle, located ahead of an own vehicle has been detected with a parallax image of a certain frame, i.e., a past image, the crossing object is tracked with a parallax image of a subsequent frame, i.e., a current image.

Such a tracking technique allows for acquisition of a movement vector of the crossing object, and thus allows for correct determination of a degree of risk of contact with the crossing object.

Based on the tracking technique described above, for example, a tracking method using an optical flow has been disclosed. Reference is made to Japanese Unexamined Patent Application Publication No. 2007-235952, for example.

The tracking method using the optical flow tracks a crossing object based on a principle that a luminance mode of the crossing object or other objects on a frame image does not change with movements of the crossing object.

Accordingly, it is possible to detect and track the crossing object by performing an optical flow analysis on preceding and subsequent frame images.

Further, the tracking method using the optical flow is subject to less limitation on a movement range of the crossing object between frame images, and is executable even when a position of the crossing object greatly changes between the frame images.

### SUMMARY

An aspect of the disclosure provides an image processing apparatus. The image processing apparatus includes a distance histogram generator, a computation processor, a memory, an extractor, a movement amount calculator, and an image processing control processor. The distance histogram generator is configured to generate, for each horizontal angle of view of an imaging unit mounted on a vehicle, a distance histogram as one-dimensional distance data, based on distance data of a distance image captured by the imaging unit. The distance image has a pixel value corresponding to a distance to a crossing object in captured images of a region in front of the vehicle. The computation processor is configured to compute edge histogram data for each distance histogram generated by the distance histogram generator. The memory is configured to hold at least the distance histogram generated by the distance histogram generator and the edge histogram data computed by the computation processor in association with each other. The extractor is configured to extract, from the edge histogram data computed in the past by the computation processor, any edge histogram data that matches with the edge histogram data computed latest by the computation processor. The movement amount calculator is configured to calculate the amount of movement of the crossing object in a direction of width of the vehicle, based on a difference value between the extracted edge histogram data computed in the past by the computation processor and the edge histogram data computed latest by the computation processor. The image processing control processor configured to execute image processing control.

An aspect of the disclosure provides an image processing apparatus. The image processing apparatus includes one or more processors and one or more memories communicably coupled to the one or more processors. The one or more processors are configured to: generate a distance histogram as one-dimensional distance data, by subjecting distance data of a distance image captured by an imaging unit mounted on a vehicle to compression at each horizontal angle of view of the imaging unit, the distance image having a pixel value corresponding to a distance to a crossing object in captured images of a region in front of the vehicle: compute edge histogram data for each distance histogram generated; extract, from the edge histogram data computed in the past, any edge histogram data that matches with the edge histogram data computed latest: calculate the amount of movement of the crossing object in a direction of width of the vehicle, based on a difference value between the extracted edge histogram data computed in the past and the edge histogram data computed latest: and execute image processing control. The one or more memories are configured to hold at least the distance histogram generated by the one or more processors and the edge histogram data computed by the one or more processors in association with each other.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of an in-vehicle system including an image processing apparatus according to one example embodiment of the disclosure.

FIG. 2 is a diagram illustrating a configuration of a processor in a data processing unit illustrated in FIG. 1.

FIG. 3 is a diagram exemplifying a distance histogram generated by a distance histogram generator in the data processing unit illustrated in FIG. 1.

FIG. 4 is a diagram exemplifying a computation region in which computation is to be performed on the distance histogram by a computation processor of the data processing unit illustrated in FIG. 1.

FIG. 5 is a diagram exemplifying a way of shifting of the computation region.

FIG. 6 is a diagram illustrating a flow of processes to be performed by the image processing apparatus illustrated in FIG. 1.

FIG. 7 is a diagram illustrating a process flow related to an extraction process by the image processing apparatus illustrated in FIG. 1.

### DETAILED DESCRIPTION

A tracking method using an optical flow takes account of changes in size with respect to a crossing object, and therefore involves prediction of movements not only in a horizontal direction but also in a front-back direction in an angle of view.

Accordingly, the tracking method using the optical flow involves a huge overall amount of computation in, for example, an alignment process (a matching process) between a current image and a past image. This makes it difficult to achieve high real-timeness.

It is desirable to provide an image processing apparatus that reduces a load of a computation process and improves real-timeness in tracking of a crossing object.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Example Embodiment

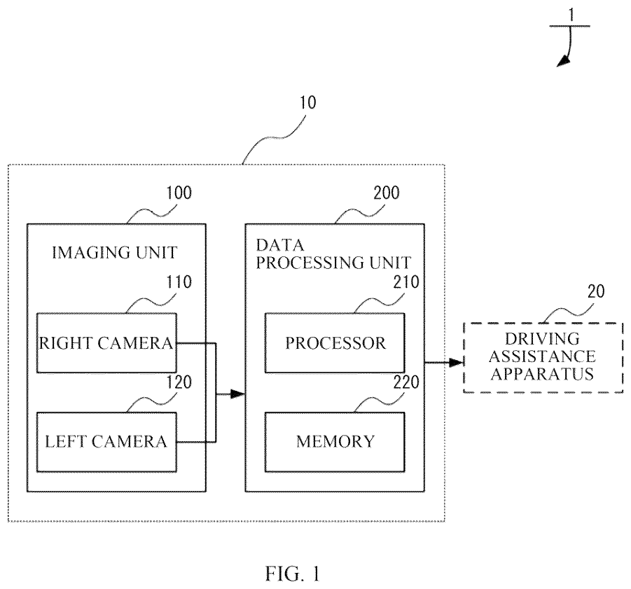

An image processing apparatus 10 according to an example embodiment will be described with reference to FIGS. 1 to 7.

It should be noted that the following will describe the image processing apparatus 10 in conjunction with, by way of example, an in-vehicle system 1 including the image processing apparatus 10.

### [In-Vehicle System 1]

As illustrated in FIG. 1, the in-vehicle system 1 according to the example embodiment may include the image processing apparatus 10 and a driving assistance apparatus 20.

The image processing apparatus 10 may include an imaging unit 100 and a data processing unit 200.

The image processing apparatus 10 may perform image processing on a distance image captured by the imaging unit 100 to calculate the amount of movement of a crossing object in a direction of width of an own vehicle, and may output data on the calculated amount of movement to the driving assistance apparatus 20.

Details of the image processing apparatus 10 will be described later.

Examples of the crossing object may include another vehicle, a human, an animal, and any other moving objects.

The driving assistance apparatus 20 may include a microcomputer including, without limitation, a central processing unit (CPU), a read only memory (ROM), a random access memory (RAM), and an interface (I/O) that are unillustrated.

The driving assistance apparatus 20 may execute control on a body of the own vehicle or various in-vehicle devices of the own vehicle based on data obtained from the image processing apparatus 10, for example.

Examples of the control on the body of the own vehicle may include alarm notifications to occupants, control on a steering wheel angle of the own vehicle, and braking control on the own vehicle.

The imaging unit 100 is mountable on a vehicle and may capture a distance image having a pixel value corresponding to a distance to the crossing object in captured images of a region in front of the vehicle.

The imaging unit 100 may include a stereo camera, for example. As illustrated in FIG. 1, the imaging unit 100 may include a right camera 110 and a left camera 120.

The imaging unit 100 may generate the distance image by performing a stereo matching process between a right image captured by the right camera 110 and a left image captured by the left camera 120.

A known technique may be used to generate the distance image.

The right camera 110 and the left camera 120 may include respective image sensors, such as charge coupled device (CCD) sensors or complementary metal-oxide-semiconductor (CMOS) sensors, that operate in synchronization with each other.

For example, the right camera 110 and the left camera 120 may be mounted on an inner side of a windshield of the vehicle at the same height from a road surface, with a predetermined spacing between the two cameras in the direction of width of the vehicle.

The right camera 110 and the left camera 120 may capture images of the region in front of the vehicle and in the vicinity thereof repeatedly at predetermined intervals, e.g., at intervals of 0.1 seconds.

The imaging unit 100 may employ a direct time-of-flight (ToF) method.

As illustrated in FIG. 1, the data processing unit 200 may include a processor 210 and a memory 220. Examples of the memory 220 may include a RAM and a ROM.

In accordance with a program stored in the memory 220, the processor 210 of the data processing unit 200 may execute image processing on the distance image obtained from the imaging unit 100 and having the pixel value corresponding to the distance to the crossing object.

### [Configuration of Processor 210]

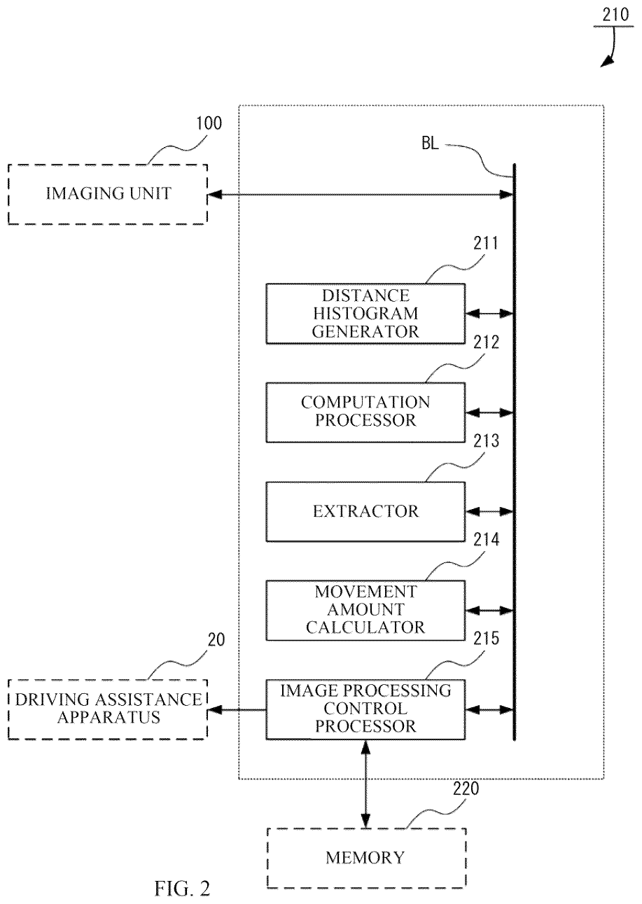

As illustrated in FIG. 2, the processor 210 according to the example embodiment may include a distance histogram generator 211, a computation processor 212, an extractor 213, a movement amount calculator 214, and an image processing control processor 215.

The distance histogram generator 211 generates, for each horizontal angle of view of the imaging unit 100, a distance histogram (a Z-peak) as one-dimensional distance data, based on distance data of the distance image captured by the imaging unit 100.

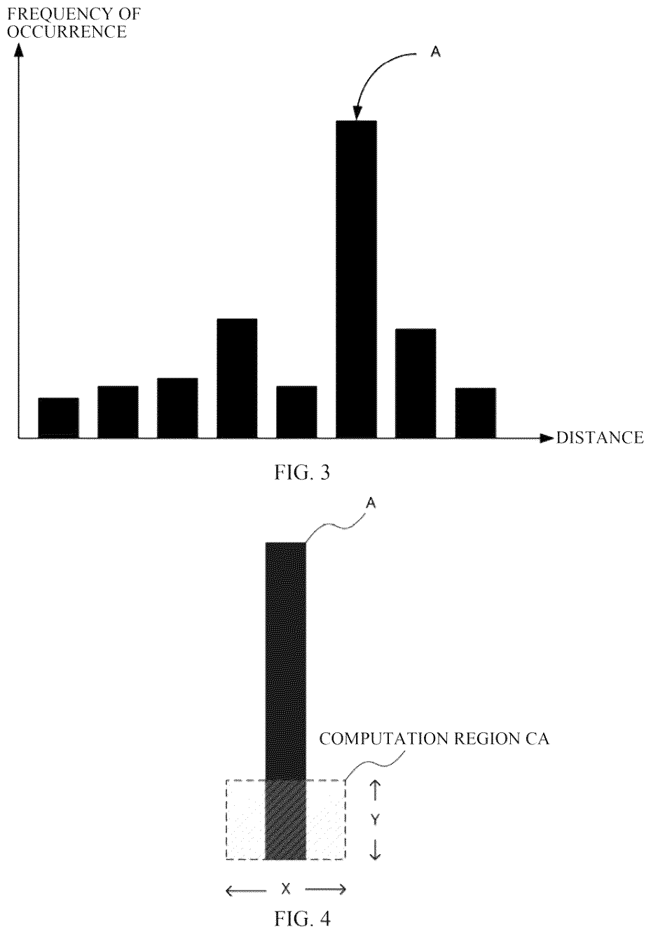

The distance histogram generated by the distance histogram generator 211 may be represented by a form illustrated in FIG. 3, for example, where the horizontal axis represents distance and the vertical axis represents frequency of occurrence.

In the following description, for example, a distance of “A” indicated in FIG. 3 shall be a distance histogram at any horizontal pixel.

The distance histogram generator 211 may output the generated distance histogram to the computation processor 212 via the image processing control processor 215. The computation processor 212 and the image processing control processor 215 will be described later.

The computation processor 212 computes edge histogram data for each distance histogram generated by the distance histogram generator 211.

The edge histogram data computed by the computation processor 212 may be associated with the distance histogram and stored in the memory 220.

The computation processor 212 may compute the edge histogram data in a rectangular computation region that is set by the image processing control processor 215 as a region in which the edge histogram data corresponding to a size of the distance indicated by the distance histogram is to be computed.

The distance histogram may include data on a distance from the imaging unit 100 and data on a position in a horizontal direction in the angle of view: Accordingly, in one example, as illustrated in FIG. 4, an X×Y computation region CA having a rectangular shape and corresponding to the size on the screen may be set for the distance histogram by the image processing control processor 215, for a computation process by the computation processor 212.

The computation processor 212 may compute the edge histogram data while shifting the computation region CA vertically from the road surface.

In one example, the computation processor 212 may compute the edge histogram data while shifting the computation region CA in a manner in which a preceding computation region CA and a subsequent computation region CA overlap each other sequentially.

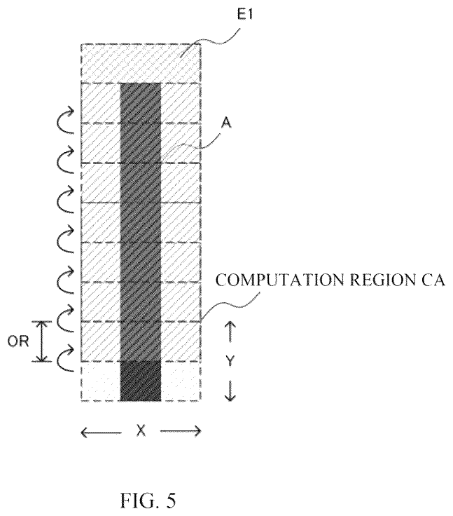

In the example embodiment illustrated in FIG. 4, the computation region CA may be set so that X=60 cm and Y=40 cm. As illustrated in FIG. 5, the computation processor 212 may compute the edge histogram data for the distance histogram while shifting the computation region CA on the distance histogram in a direction vertical to the road surface, with an overlap (OR) of 20 cm being made between the preceding computation region CA and the subsequent computation region CA sequentially.

It should be noted that the numerical values presented above are examples, and other values may be used depending on specification of the apparatus.

At this time, the computation processor 212 may refrain from executing the computation process in any computation region CA that includes no height data in which the distance data is present in the distance histogram.

Further, the computation processor 212 may compute a luminance gradient as the edge histogram data and determine an edge distribution, i.e., a histogram of oriented gradients (HOG) or a luminance gradient histogram, for each distance histogram.

A known technique may be used for computation of the luminance gradient histogram or the HOG.

The computation processor 212 may output the edge histogram data as a computation result to the extractor 213 described below via the image processing control processor 215.

The extractor 213 extracts, from the edge histogram data computed in the past by the computation processor 212 and stored in the memory 220, any edge histogram data that matches with the edge histogram data computed latest by the computation processor 212, i.e., the edge histogram data for the current distance histogram.

The extractor 213 may define, as one or more matching targets, one or more pieces of the edge histogram data computed in the past, included in a search range set by the image processing control processor 215, and each having a height difference within a first threshold from the distance histogram generated by the distance histogram generator 211, i.e., the current distance histogram.

The “search range” to be used in extracting the matching targets may be, for example, a range resulting from combining the amount of movement of the own vehicle and a maximum amount of movement of the crossing object.

The “first threshold” may be set to any value in accordance with, for example, the specification of the apparatus.

The extractor 213 may define, as the one or more matching targets, one or more pieces of the edge histogram data computed in the past, included in the search range set by the image processing control processor 215, and exhibiting a change in speed within a second threshold relative to the distance histogram generated by the distance histogram generator 211, i.e., the current distance histogram.

The “second threshold” may be set to any value in accordance with, for example, the specification of the apparatus.

The extractor 213 may determine a degree of closeness between the edge histogram data for the current distance histogram and the extracted edge histogram data computed in the past, and may perform extraction of any edge histogram data to be matched with the edge histogram data computed latest by the computation processor 212, i.e., the edge histogram data for the current distance histogram.

As a method of determining the degree of closeness, a suitable technique such as cosine similarity or Euclidean distance may be used.

The extractor 213 may output a result of the extraction to the movement amount calculator 214 described below via the image processing control processor 215.

The movement amount calculator 214 calculates the amount of movement of the crossing object in the direction of width of the own vehicle, based on a difference value between the edge histogram data computed in the past and extracted by the extractor 213 and the edge histogram data computed latest.

The movement amount calculator 214 may output the calculated amount of movement to the driving assistance apparatus 20 via the image processing control processor 215.

The image processing control processor 215 may control processes to be performed by the entire data processing unit 200 in accordance with a control program stored in, for example, the ROM of the memory 220.

As illustrated in FIG. 2, the image processing control processor 215 may be electrically coupled to the imaging unit 100, the distance histogram generator 211, the computation processor 212, the extractor 213, and the movement amount calculator 214 via a bus line BL.

In the example embodiment, the image processing control processor 215 may cause the imaging unit 100, the distance histogram generator 211, the computation processor 212, the extractor 213, and the movement amount calculator 214 to execute predetermined processes.

Further, the image processing control processor 215 may set the computation region for the computation processor 212 and set the search range for the extractor 213 to perform matching, based on various conditions.

### [Processes to be Performed by Image Processing Apparatus 10]

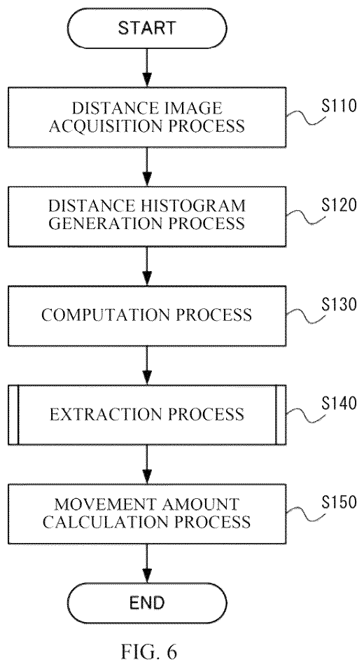

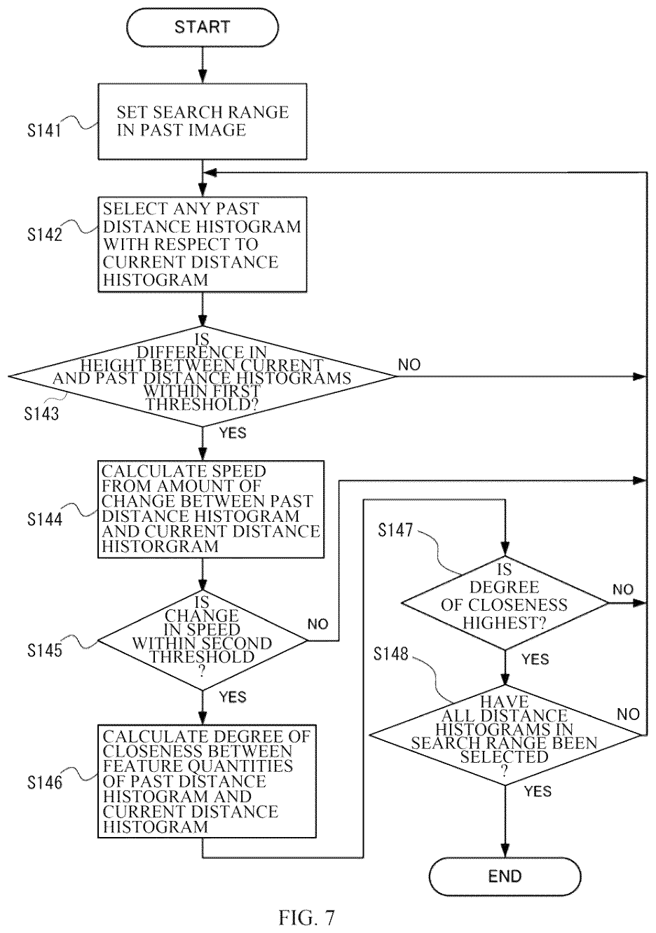

With reference to FIG. 6, a description will be given below of processes to be performed by the image processing apparatus 10 according to the example embodiment.

As illustrated in FIG. 6, the imaging unit 100 may capture a distance image by performing a stereo matching process between a right image captured by the right camera 110 and a left image captured by the left camera 120 (step S110). The distance image has a pixel value corresponding to the distance to a crossing object in captured images of the region in front of the vehicle.

The distance image captured by the imaging unit 100 may be outputted to the distance histogram generator 211 via the image processing control processor 215.

The distance histogram generator 211 generates a distance histogram (a Z-peak) as one-dimensional distance data (step S120), by subjecting distance data of the distance image captured by the imaging unit 100 to compression at each horizontal angle of view of the imaging unit 100.

The distance histogram generated by the distance histogram generator 211 may be outputted to the computation processor 212 via the image processing control processor 215.

The computation processor 212 computes edge histogram data for each distance histogram generated by the distance histogram generator 211 (step S130).

Here, the computation processor 212 may compute the edge histogram data in the rectangular computation region that is set for computation of the edge histogram data. The rectangular computation region may correspond to the size on the screen displaying the distance image.

Further, the computation processor 212 may compute the edge histogram data while shifting the rectangular computation region vertically from the road surface.

Moreover, the computation processor 212 may compute the luminance gradient as the edge histogram data, and may determine the edge distribution for each distance histogram.

The edge histogram data as a resultant of computation by the computation processor 212 may be associated with the distance histogram and stored in the memory 220 via the image processing control processor 215.

The extractor 213 extracts, from the edge histogram data computed in the past by the computation processor 212, any edge histogram data that matches with the edge histogram data computed latest by the computation processor 212 (step S140).

Details of the process to be performed by the extractor 213 will be described later.

The edge histogram data extracted by the extractor 213 from the edge histogram data computed in the past by the computation processor 212, and the edge histogram data computed latest by the computation processor 212 may be outputted to the movement amount calculator 214 via the image processing control processor 215.

The movement amount calculator 214 calculates the amount of movement of the crossing object in the direction of width of the own vehicle, based on the difference value between the edge histogram data computed in the past and extracted by the extractor 213 and the edge histogram data computed latest (step S150).

The amount of movement calculated by the movement amount calculator 214 may be outputted to the driving assistance apparatus 20 via the image processing control processor 215.

### [Processes to be Performed by Extractor 213]

Processes to be performed by the extractor 213 will be described with reference to FIG. 7.

The image processing control processor 215 may set the search range in past images for the extractor 213 (step S141).

The extractor 213 may select any of past distance histograms within the search range set for the current distance histogram (step S142).

The extractor 213 may determine whether a difference in height between the current distance histogram and the selected past distance histogram is within the first threshold (step S143).

When the extractor 213 determines that the difference in height between the current distance histogram and the selected past distance histogram is not within the first threshold (“NO” in step S143), the extractor 213 may cause the process to return to step S142.

When the extractor 213 determines that the difference in height between the current distance histogram and the selected past distance histogram is within the first threshold (“YES” in step S143), the extractor 213 may calculate speed from the amount of change between the current distance histogram and the selected past distance histogram (step S144).

Thereafter, the extractor 213 may determine whether a change in the calculated speed is within the second threshold (step S145).

When the extractor 213 determines that the change in the calculated speed is not within the second threshold (“NO” in step S145), the extractor 213 may cause the process to return to step S142.

When the extractor 213 determines that the change in the calculated speed is within the second threshold (“YES” in step S145), the extractor 213 may calculate the degree of closeness between a feature quantity (e.g., the luminance gradient) of the current distance histogram and that of the selected past distance histogram (step S146).

Thereafter, the extractor 213 may determine whether the calculated degree of closeness is the highest among those that have been calculated (step S147).

When the extractor 213 determines that the calculated degree of closeness is not the highest among those that have been calculated (“NO” in step S147), the extractor 213 may cause the process to return to step S142.

When the extractor 213 determines that the calculated degree of closeness is the highest among those that have been calculated (“YES” in step S147), the extractor 213 may store the calculated degree of closeness in the memory 220, and may determine whether all the distance histograms in the search range have been selected (step S148).

When the extractor 213 determines that not all the distance histograms in the search range have been selected (“NO” in step S148), the extractor 213 may cause the process to return to step S142.

When the extractor 213 determines that all the distance histograms in the search range have been selected (“YES” in step S148), the extractor 213 may extract the past distance histogram that is the highest in the degree of closeness as a matching target, and may output the extracted distance histogram to the image processing control processor 215 to end the process.

### Workings and Example Effects

As described hereinabove, the distance histogram generator 211 of the image processing apparatus 10 according to the example embodiment generates the distance histogram as one-dimensional distance data, by subjecting the distance data of the distance image captured by the imaging unit 100 mounted on the vehicle to compression at each horizontal angle of view of the imaging unit 100. The distance image has a pixel value corresponding to the distance to the crossing object in captured images of the region in front of the vehicle.

For example, the distance histogram may include data on the distance from the imaging unit 100 and data on the position in the horizontal direction in the angle of view: Accordingly, by calculating the amount of movement of the crossing object in the direction of width of the vehicle by using the distance histogram, it is possible to accurately recognize a positional relationship between the own vehicle and the crossing object while reducing a process load.

The computation processor 212 of the image processing apparatus 10 according to the example embodiment computes the edge histogram data for each distance histogram generated by the distance histogram generator 211. Further, the extractor 213 extracts, from the edge histogram data computed in the past by the computation processor 212, any edge histogram data that matches with the edge histogram data computed latest by the computation processor 212.

For example, the computation processor 212 may compute, for each distance histogram generated by the distance histogram generator 211, the edge histogram data that is a feature quantity of the distance histogram. Further, the extractor 213 may extract the matching target based on the edge histogram data.

Accordingly, by making a comparison between the distance histogram of the current image and the distance histogram of the past image using the computed edge histogram data, it is possible to enhance accuracy of matching, and as a result, it is possible to reduce the process load.

In some embodiments, the computation processor 212 of the image processing apparatus 10 may compute the edge histogram data in the computation region CA having the rectangular shape that is set by the image processing control processor 215 as a region in which the edge histogram data is to be computed, and that corresponds to the size on the screen displaying the distance image.

For example, it is known that when computing the feature quantity of a distance histogram, making the computation region CA variable in size allows for representation of a relation between any crossing object as a detection target that is difficult to represent in a fixed computation region CA and the background.

Accordingly, it is possible to execute the computation process efficiently by optimizing the size of the computation region CA in accordance with the specification of the apparatus.

In some embodiments, the computation processor 212 of the image processing apparatus 10 may compute the edge histogram data while causing multiple computation regions CA to sequentially overlap each other from the road surface on the screen to move to a predetermined height.

Such a process helps to increase accuracy of computation while maintaining a certain level of process speed.

In a case of a specification in which more importance is placed on the process speed than on the accuracy of computation, the process of computing the edge histogram data may be executed without any overlap between the computation regions CA.

In some embodiments, the computation processor 212 may compute the edge histogram data while causing the computation regions CA to sequentially overlap each other from the road surface on the screen to the predetermined height, and may refrain from executing the computation process in any of the computation regions CA that includes no height data in which the distance data is present in the distance histogram.

This cuts down on unnecessary computation processes and thus allows for reducing the process load of the computation.

In some embodiments, the computation processor 212 of the image processing apparatus 10 may compute the luminance gradient as the edge histogram data and determine the edge distribution for each distance histogram.

By computing the luminance gradient and determining the edge distribution for each distance histogram at the computation processor 212, high accuracy of extraction is achievable at the extractor 213.

This helps to accurately sort the matching targets, and thus helps to achieve a reduction in the load of the computation process.

In some embodiments, the extractor 213 of the image processing apparatus 10 may define, as one or more matching targets, one or more pieces of the edge histogram data computed in the past, included in the search range set by the image processing control processor 215, and each having a height difference within the first threshold from the distance histogram generated by the distance histogram generator 211.

For example, the matching targets are narrowed down under the limited search range set by the image processing control processor 215 and the condition that the height difference from the distance histogram should be within the first threshold. This helps to achieve a reduction in the process load.

In some embodiments, the extractor 213 of the image processing apparatus 10 may define, as the one or more matching targets, one or more pieces of the edge histogram data computed in the past, included in the search range set by the image processing control processor 215, and each exhibiting a change in speed within the second threshold relative to the distance histogram generated by the distance histogram generator 211.

For example, the matching targets are narrowed down under the limited search range set by the image processing control processor 215 and the condition that the change in speed relative to the distance histogram should be within the second threshold. This helps to achieve a reduction in the process load.

In some embodiments, the extractor 213 of the image processing apparatus 10 may determine the degree of closeness between the edge histogram data computed latest and each of the one or more pieces of the edge histogram data defined as the one or more matching targets, and may extract any edge histogram data to be matched with the edge histogram data computed latest by the computation processor 212.

For example, the edge histogram data to be matched may be extracted by determining the degree of closeness of the matching targets to the computed edge histogram data, the matching targets having been narrowed down under the limited search range set by the image processing control processor 215 and the condition that the height difference from the distance histogram should be within the first threshold or the condition that the change in speed relative to the distance histogram should be within the second threshold. This helps to achieve a further reduction in the process load.

In this way, it is possible for the image processing apparatus to reduce the load on the computation process and to improve real-timeness in tracking of the crossing object.

### Modification Example 1

History data on speed may be added for each distance histogram. When a current speed deviates from an average value of speeds in the history data, the extractor 213 may remove, from the matching targets, any distance histogram in which the current speed deviates from the average value of the speeds in the history data by a certain value or more.

Performing such a process allows for reducing the matching targets at an early stage, and thus helps to reduce the process load.

### Modification Example 2

History data on speed may be added for each distance histogram, and any distance histogram different in speed from surrounding distance histograms by a certain value or more may be removed from the matching targets.

Performing such a process allows for reducing the matching targets at an early stage, and thus helps to reduce the process load.

It is possible to implement the image processing apparatus 10 of the example embodiment of the disclosure by recording the process to be executed by the processor 210 on a non-transitory recording medium readable by a computer system, and causing the computer system to load the program recorded on the non-transitory recording medium onto the processor 210 to execute the program. The computer system as used herein may encompass an operating system (OS) and hardware such as a peripheral device.

In addition, when the computer system utilizes a World Wide Web (WWW) system, the “computer system” may encompass a website providing environment (or a website displaying environment). The program may be transmitted from a computer system that contains the program in a storage device or the like to another computer system via a transmission medium or by a carrier wave in a transmission medium. The “transmission medium” that transmits the program may refer to a medium having a capability to transmit data, including a network (e.g., a communication network) such as the Internet and a communication link (e.g., a communication line) such as a telephone line.

Further, the program may be directed to implement a part of the operation described above. The program may be what is called a differential file (differential program) configured to implement the operation by a combination of a program already recorded on the computer system.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

One or more of the distance histogram generator 211, the computation processor 212, the extractor 213, the movement amount calculator 214, and the image processing control processor 215 illustrated in FIG. 2 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of one or more of the distance histogram generator 211, the computation processor 212, the extractor 213, the movement amount calculator 214, and the image processing control processor 215. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of one or more of the distance histogram generator 211, the computation processor 212, the extractor 213, the movement amount calculator 214, and the image processing control processor 215 illustrated in FIG. 2.

1. An image processing apparatus comprising:
a distance histogram generator configured to generate, for each horizontal angle of view of an imaging unit mounted on a vehicle, a distance histogram as one-dimensional distance data, based on distance data of a distance image captured by the imaging unit, the distance image having a pixel value corresponding to a distance to a crossing object in captured images of a region in front of the vehicle;
a computation processor configured to compute edge histogram data for each distance histogram generated by the distance histogram generator;
a memory configured to hold at least the distance histogram generated by the distance histogram generator and the edge histogram data computed by the computation processor in association with each other;
an extractor configured to extract, from the edge histogram data computed in a past by the computation processor, any edge histogram data that matches with the edge histogram data computed latest by the computation processor;
a movement amount calculator configured to calculate an amount of movement of the crossing object in a direction of width of the vehicle, based on a difference value between the extracted edge histogram data computed in the past by the computation processor and the edge histogram data computed latest by the computation processor; and
an image processing control processor configured to execute image processing control.

2. The image processing apparatus according to claim 1, wherein the computation processor is configured to compute the edge histogram data in a rectangular computation region that is set by the image processing control processor as a region in which the edge histogram data is to be computed, the rectangular computation region corresponding to a size on a screen displaying the distance image.

3. The image processing apparatus according to claim 2, wherein
the rectangular computation region comprises a plurality of the rectangular computation regions, and
the computation processor is configured to compute the edge histogram data while causing the rectangular computation regions to sequentially overlap each other from a road surface on the screen to move to a predetermined height.

4. The image processing apparatus according to claim 3, wherein the computation processor is configured to refrain from executing any computation process in any of the rectangular computation regions that includes no height data in which the distance data is present in the distance histogram.

5. The image processing apparatus according to claim 4, wherein the computation processor is configured to compute a luminance gradient as the edge histogram data and to determine an edge distribution for each distance histogram.

6. The image processing apparatus according to claim 1, wherein the extractor is configured to define, as one or more matching targets, one or more pieces of the distance histogram data computed in the past, included in a search range set by the image processing control processor, and each having a height difference within a first threshold from the distance histogram generated by the distance histogram generator.

7. The image processing apparatus according to claim 6, wherein the extractor is configured to define, as the one or more matching targets, one or more pieces of the edge histogram data computed in the past, included in the search range set by the image processing control processor, and each exhibiting a change in speed within a second threshold relative to the distance histogram generated by the distance histogram generator.

8. The image processing apparatus according to claim 6, wherein the extractor is configured to determine a degree of closeness between the edge histogram data computed latest by the computation processor and each of the one more pieces of the edge histogram data defined as the one or more matching targets, and to extract any edge histogram data to be matched with the edge histogram data computed latest.

9. The image processing apparatus according to claim 7, wherein the extractor is configured to determine a degree of closeness between the edge histogram data computed latest by the computation processor and each of the one more pieces of the edge histogram data defined as the one or more matching targets, and to extract any edge histogram data to be matched with the edge histogram data computed latest.

10. An image processing apparatus comprising
one or more processors, and
one or more memories communicably coupled to the one or more processors, wherein
the one or more processors are configured to:
generate, for each horizontal angle of view of an imaging unit mounted on a vehicle, a distance histogram as one-dimensional distance data, based on distance data of a distance image captured by the imaging unit, the distance image having a pixel value corresponding to a distance to a crossing object in captured images of a region in front of the vehicle;
compute edge histogram data for each distance histogram generated;
extract, from the edge histogram data computed in a past, any edge histogram data that matches with the edge histogram data computed latest;
calculate an amount of movement of the crossing object in a direction of width of the vehicle, based on a difference value between the extracted edge histogram data computed in the past and the edge histogram data computed latest; and
execute image processing control, and
the one or more memories are configured to hold at least the distance histogram generated by the one or more processors and the edge histogram data computed by the one or more processors in association with each other.
